(19) United States
(12) Patent Application Publication
(10) Pub. No.: US 2020/0141769 A1
(43) Pub. Date: May 7, 2020

(54) METHOD FOR PROCESSING LONG-DISTANCE OPTICAL FIBER DISTRIBUTED DISTURBANCE SENSING SIGNAL BASED ON OPTICAL FREQUENCY DOMAIN REFLECTOMETRY

(71) Applicant: TIANJIN QIUSHI FIBER TECHNOLOGIES CO., LTD., Tianjin (CN)

(72) Inventor: Ke LIU, Tianjin (CN)

(73) Assignee: TIANJIN QIUSHI FIBER TECHNOLOGIES CO., LTD., Tianjin (CN)

(21) Appl. No.: 16/482,231

(22) PCT Filed: Mar. 21, 2018
(86) PCT No.: PCT/CN2018/079799

§ 371 Date: Jul. 30, 2019

(30) Foreign Application Priority Data
Jul. 27, 2017 (CN) 201710635645.6

(51) Int. Cl. G01D 5/353; G06T 5/00; G06T 5/20

(52) U.S. Cl. CPC G01D 5/35361; G06T 5/20; G06T 5/002

(57) ABSTRACT

The present invention provides a method for processing long-distance optical fiber distributed disturbance sensing signal based on optical frequency domain reflectometry, including: denoising and reinforcing feature points to measurement signals by using a 2D image processing method; using a noise reduction method without loss of spatial resolution and using low pass filtering to make the disturbance position more prominent while ensuring the spatial resolution, thus distinguishing multi-point disturbances. The present invention utilizes an image processing method to effectively reduce noise and preserve disturbance feature information. When distinguishing multi-point disturbance, the present invention adopts the noise reduction method without spatial resolution loss and uses low-pass filtering to reduce noise, which makes the disturbance position more prominent while ensuring the spatial resolution.

### FIELD OF THE INVENTION

The present invention relates to the technical filed of optical fiber sensors, and in particular to a method for processing long-distance optical fiber distributed disturbance sensing signal based on optical frequency domain reflectometry.

### BACKGROUND OF THE INVENTION

Long-distance distributed disturbance sensing is widely used in many fields such as people's livelihood and national defense security, structural health monitoring key parts of aircraft, spacecraft, ships, defense equipment, industrial equipment, bridge culverts, etc., using optical frequency domain reflectometry of the single-mode fiber Rayleigh scattering spectrum so as to achieve high precision and high spatial resolution long-distance distributed disturbance sensing.

In the existing optical fiber disturbance sensing based on optical frequency domain reflectometry, most of the prior art exists problems such as the multi-point disturbance position cannot be distinguished, large sensing signal noise is large, and the spatial resolution is low

### SUMMARY OF THE INVENTION

The objective of the present invention is to provide a method for processing long-distance optical fiber distributed disturbance sensing signal based on optical frequency domain reflectometry, so that the existing problems such as the multi-point disturbance position cannot be distinguished, large sensing signal noise is large, and the spatial resolution is low can be overcome.

For this purpose, the technical scheme of the present invention is as follows:

A method for processing long-distance optical fiber distributed disturbance sensing signal based on optical frequency domain reflectometry, the steps are as follows:

S1: denoising and reinforcing feature points to measurement signals by using an image processing method;
S2: using a noise reduction method without loss of spatial resolution and using low pass filtering to make the disturbance position more prominent while ensuring the spatial resolution, thus distinguishing multi-point disturbances;

Further, step S1 including the following steps:

S101: forming a beat interference signal by fiber back Rayleigh scattering in a main interferometer of the optical frequency domain reflectometer;
S102: partitioning the beat frequency interference signal along the time axis, and performing fast Fourier transform on the partitioned signals;
S103: setting the signals as an image by taking time and distance as coordinates by using the time-frequency analysis method;
S104: denoising the image by using the local mean filtering method, obtaining average value of time domain information corresponding to each position and synthesizing the average values into a spatial domain information.

Further, the step of “distinguishing a multi-point disturbance” comprising: Performing Fourier transform on the spatial domain signal, setting the high frequency information to zero, and then inverting the optical frequency domain back to spatial domain to achieve low pass filtering, positioning a trough of the spatial domain signal by the fiber back Rayleigh scattering, the position of the trough being the second disturbance position; and distinguishing multi-point disturbances by the above method.

Compared to prior art, the method of the present invention has the following advantages:

The present invention utilizes an image processing method to effectively reduce noise and preserve disturbance feature information. When distinguishing multi-point disturbance, the present invention adopts the noise reduction method without spatial resolution loss and uses low-pass filtering to reduce noise, which makes the disturbance position more prominent while ensuring the spatial resolution.

### BRIEF DESCRIPTION OF THE DRAWINGS

The accompanying drawings illustrate one or more embodiments of the present disclosure and, together with the written description, serve to explain the principles of the disclosure, the present invention is not limited thereto.

FIG. 1 is a schematic diagram of a method for processing a long-distance optical fiber distributed disturbance sensing signal based on optical frequency domain reflectometry of the present invention;

FIG. 2 is a two-dimensional image by using the time-frequency analysis method; and

FIG. 3 is an image after noise reduction.

### DETAILED DESCRIPTION OF THE INVENTION WITH EMBODIMENTS

It should be noted that the embodiments in the present invention and the features in the embodiments may be combined with each other in the case of no conflict.

For purpose of this specification, unless otherwise explicitly defined and limited, the terms such as “center”, “longitudinal”, “transverse”, “up”, “down”, “front”, “back”, “left”, “right”, “vertical”, “horizontal”, “top”, “bottom”, “inside” and “outside” are based on the orientation or positional relationship shown in the drawings, and are merely for facilitating the description of the present invention, rather than indicating or implying the device or component referred to, and are not limited thereto. Further, the terms such as “first”, “second” are used for descriptive purposes only and are not to be understood as indicating or implying an importance or implicitly indicating the number of technical features indicated. Accordingly, the features comprising the terms such as “first”, “second” indicate or implicitly indicate one or more than one technical features. In the description of the present invention, unless otherwise stated, “a plurality” means two or more.

For purpose of this specification, unless otherwise explicitly defined and limited, the term “fix”, “connect” are intended to be interpreted broadly, for example, referring to a fixed connection, a detachable connection, or an integral connection, or a mechanical connection or an electrical connection; or a direct connection, an indirect connection through an intermediate medium, or a communication between two elements. The specific meaning of the above terms in the present invention can be understood by a person skilled in the art.

The invention will be described in detail below with reference to the drawings in conjunction with the embodiments.

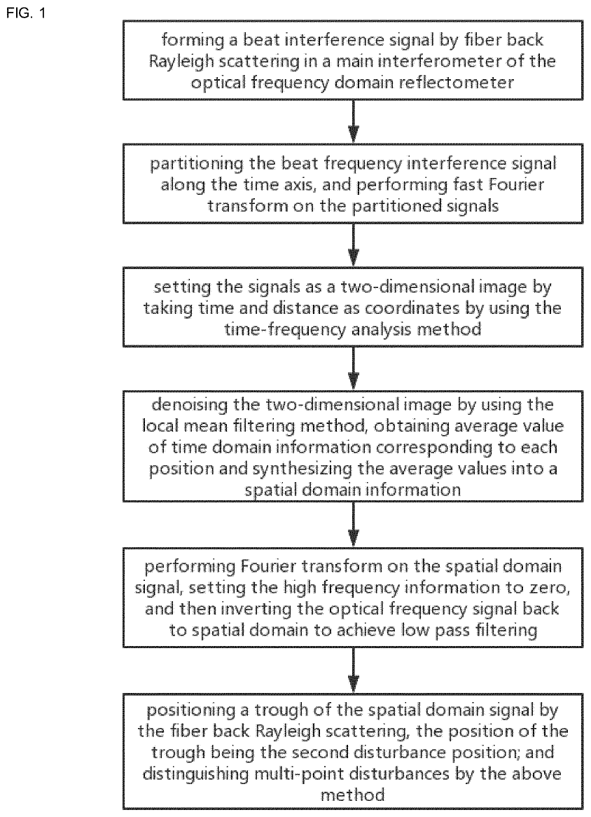

As shown in FIG. 1, a method for processing long-distance optical fiber distributed disturbance sensing signal based on optical frequency domain reflectometry, the steps are as follows:

(1) forming a beat interference signal by fiber back Rayleigh scattering in a main interferometer of the optical frequency domain reflectometer; partitioning the beat frequency interference signal along the time axis, and performing fast Fourier transform on the partitioned signals; setting the signals as a 2D image by taking time and distance as coordinates by using the time-frequency analysis method;
(2) denoising the 2D image by using the local mean filtering method, obtaining average value of time domain information corresponding to each position and synthesizing the average values into a spatial domain information;
(3) performing Fourier transform on the spatial domain signal, setting the high frequency information to zero, and then inverting the optical frequency domain signal back to spatial domain to achieve low pass filtering, positioning a trough of the spatial domain signal by the fiber back Rayleigh scattering, the position of the trough being the second disturbance position; and distinguishing multi-point disturbances by the above method.

The present invention adopts components comprising: a GPIB control module, a computer, a main interferometer, an additional interferometer, an acquisition device and a tunable laser source. The main interferometer is the core of the optical frequency domain reflectometer, which is a modified Mach-Zehnder interferometer.

The working principle of the present invention is as follows:

During operation, the computer controls the tunable laser to control the tuning speed, the center wavelength, start of the tuning, etc. by using the GPIB control module; the optical frequency domain reflectometer senses the emergent light emitted from the tunable laser and outputs the signal light, and the signal light is then received by the acquisition device and sent to the computer.

The principle of disturbance sensing is as follows: assuming that there is a disturbance event at a certain position in the fiber to be tested, and the vibration thereof causes a phase change of the test light field E in the testing arm and a change in the loss reflectance R. The phase change caused by vibration can be expressed as:

Δφ=δ sin(2πf_m t)

In which, f_m is a vibration frequency, δ is a modulation amplitude of the phase. The loss reflectance is reduced due to the vibration, causing the amplitude of the spatial domain signal to decrease. The novel algorithm of calculating and measuring the multi-point disturbance of the present invention utilizes the above principle characteristics to perform disturbance position detection.

The principle of time-frequency analyzing the 2D image of the disturbance signal is as follows: partitioning the beat frequency interference signal along the time axis, and performing fast Fourier transform on the partitioned signals to obtain a two-dimensional signal consisting time and frequency variables; and processing the two-dimensional signal to a 2D image. By using the local mean filtering method, the present invention effectively reduces the noise in the sensing signal, and preserves the disturbance feature information.

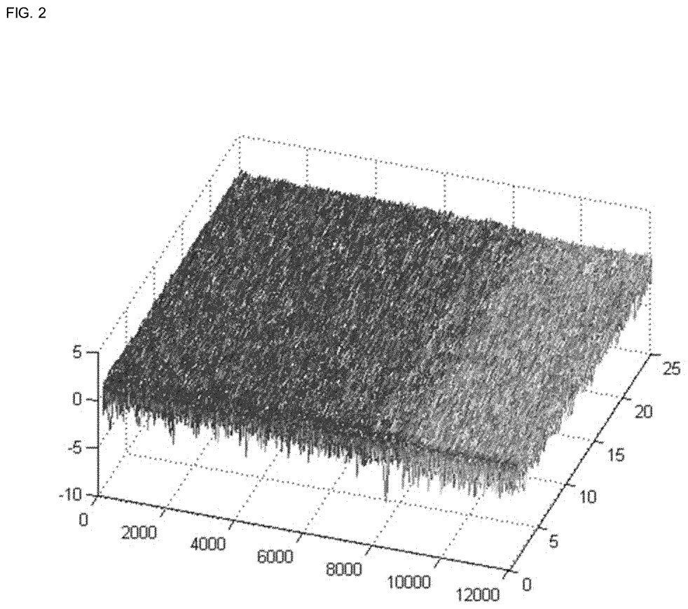

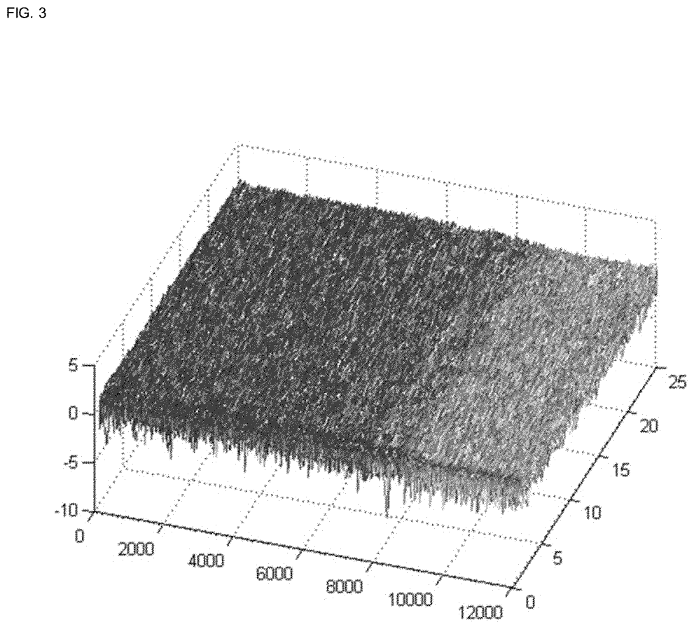

FIG. 2 is a two-dimensional image, the horizontal and vertical coordinates of which are time and distance respectively. FIG. 2 shows the processed image by local average filtering, it is apparently that the noise is significantly suppressed. FIG. 3 shows the restored spatial domain image after processing.

The foregoing specific implementations are merely illustrative but not limiting. A person of ordinary skill in the art may make various forms under the teaching of the present invention without departing from the purpose of the present invention and the protection scope of the appended claims, and all the forms shall fall into the protection scope of the present invention.

What is claimed is:

1. A method for processing long-distance optical fiber distributed disturbance sensing signal based on optical frequency domain reflectometry, including:
S1: denoising and reinforcing feature points to measurement signals by using an image processing method;
S2: using a noise reduction method without loss of spatial resolution and using low pass filtering to make the disturbance position more prominent while ensuring the spatial resolution, thus distinguishing multi-point disturbances.

2. The method according to claim 1, wherein the step S1 including the following steps:
S101: forming a beat interference signal by fiber back Rayleigh scattering in a main interferometer of the optical frequency domain reflectometer;
S102: partitioning the beat frequency interference signal along the time axis, and performing fast Fourier transform on the partitioned signals;
S103: setting the signals as a two-dimensional image by taking time and distance as coordinates by using the time-frequency analysis method;
S104: denoising the two-dimensional image by using the local mean filtering method, obtaining average value of time domain information corresponding to each position and synthesizing the average values into a spatial domain information.

3. The method according to claim 1, wherein the step of “distinguishing a multi-point disturbance” comprising:
Performing Fourier transform on the spatial domain signal, setting the high frequency information to zero, and then inverting the optical frequency signal back to spatial domain to achieve low pass filtering, positioning a trough of the spatial domain signal by the fiber back Rayleigh scattering, the position of the trough being the second disturbance position; and distinguishing multi-point disturbances by the above method.
